(19) United States
(12) Patent Application Publication
(10) Pub. No.: US 2004/0202285 A1
(43) Pub. Date: Oct. 14, 2004

(54) Versatile C-arm assembly

(76) Inventor: Michael A. Masini, Ann Arbor, MI (US)

Correspondence Address: John G. Posa, Gifford, Krass, Groh, Sprinkle,, Anderson & Citkowski, P.C., 280 N. Old Woodward Ave., Suite 400, Birmingham, MI, 48009-5394, US

(21) Appl. No.: 10/409,942

(22) Filed: Apr. 9, 2003

(51) Int. Cl. H05G 1/02

(52) U.S. Cl. 378/197

(57) ABSTRACT

An improved C-arm assembly for multiple imaging of a target broadly comprising a first emitter-detector pair arranged to image the target along a first axis, and a second emitter-detector pair, physically coupled to the first emitter-detector pair, for imaging the target along a second axis different from the first. Conveniently, the first and second axes may be arranged orthogonal to one another, facilitating simultaneous or near-simultaneous anterior-posterior (AP) and lateral views, for example. Various physical configurations are possible according to the invention. For example, the relationship between both emitter-detector pairs may be fixed on a separate C-arm physically coupled to one another in sliding fashion. That is, at least a portion of the first and second C-arms may be co-extensive with one another, or at least a portion of the second C-arm slidingly engages within or beside the first C-arm.

### FIELD OF THE INVENTION

This invention relates generally to radiology and, in particular, to C-arm apparatus that allows for multiple views through a target, including orthogonal views, using the same piece of equipment.

### BACKGROUND OF THE INVENTION

C-arm fluoroscopic imaging systems having become an invaluable aid in the operating room, particularly with respect to trauma situations. FIG. 1 is a diagram that shows a typical prior-art assembly, depicted generally at 100. The system includes an x-ray emitter 102 in a fixed, opposing relationship to a detector 104, both of which are mounted on a C-shaped arm 106, hence the name. The arm 106 is supported by a mechanism 108 that allows the arm to rotate about an axis to obtain an optimal view of a target 101.

The mechanism 108 is coupled to some form of arm 110 which is in turn either coupled to a cart 112, or a ceiling mount 120. Various commercially available C-arm systems are available from such companies as Hologic, Fluorscan, General Electric and others.

While existing machines offer increasing resolution, ease of use and other user-friendly features, it is often the case that the attending physician or surgeon must reposition the same instrument so as to take a second view through the target at an orthogonal angle. This is the case, for example, when repairing a fracture or related orthopedic work, where a view through the sagittal as well as A-P plane is required for implant placement, repair, or other considerations.

According to current practice, to obtain these orthogonal views, the attending physician/surgeon can either reposition the same C-arm or, alternatively, set up two C-arms at right angles to one another in advance of a procedure. Both of these solutions are problematic and prolong the procedure. To use the same C-arm, although newer units are relatively easy to adjust, consumes needless time in the operating room, often when the well being of a patient may be at stake. Although setting up two C-arms in advance theoretically only consumes time prior to a particular procedure. C-arms take up room in the operating room, and must also be displaced from another, such that different views of the same target are not physically possible.

Clearly then, the need remains for improved C-arm apparatus that allows simultaneous views of the target to expedite certain trauma approaches and other applications.

### SUMMARY OF THE INVENTION

This invention resides in an improved C-arm assembly for imaging a target, broadly comprising a first emitter-detector pair arranged to image the target along a first axis, and a second emitter-detector pair, physically coupled to the first emitter-detector pair, for imaging the target along a second axis different from the first. Conveniently, the first and second axes may be arranged orthogonal to one another, facilitating simultaneous or near-simultaneous anterior-posterior (AP) and lateral views, for example.

Various physical configurations are possible according to the invention. For example, the relationship between both emitter-detector pairs may be fixed on a separate C-arm physically coupled to one another in sliding fashion. That is, at least a portion of the first and second C-arms may be co-extensive with one another, or at least a portion of the second C-arm slidingly engages within or beside the first C-arm.

### BRIEF DESCRIPTION OF THE DRAWINGS

FIG. 1 is a diagram that shows a typical prior-art C-arm assembly;

FIG. 2 is a simplified diagram of one embodiment of the invention, wherein two C-arms are adjustably mounted on the same support;

FIG. 3 shows how a second emitter-detector pair may be rotated to obtain different views;

FIG. 4 illustrates a further alternative embodiment of the invention, wherein a first C-arm having an emitter and detector is slidingly engaged in a mount, and a second C-arm, having a second emitter-detector pair is received by the first C-arm as an inner concentric ring; and

FIG. 5 depicts a portion of an operator interface made possible by the invention.

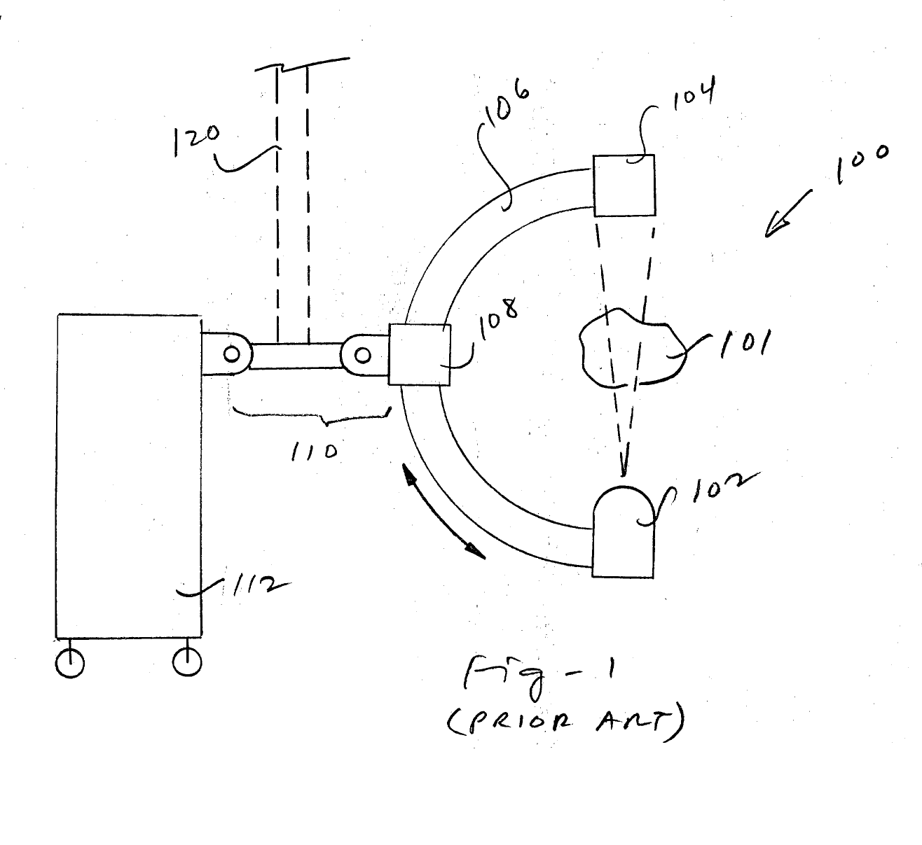

### DETAILED DESCRIPTION OF THE INVENTION

Broadly, this invention supports multiple emitters and detectors on the same C-arm assembly, allowing a user to obtain multiple views of the same target simultaneously, including views that are orthogonal to one another. Although this approach duplicates a portion of the instrument, namely, the X-ray source and detector assembly, these components are becoming increasingly economical with increased manufacture, and many other portions of the system, including image processing. Electronics and software may be used for both views.

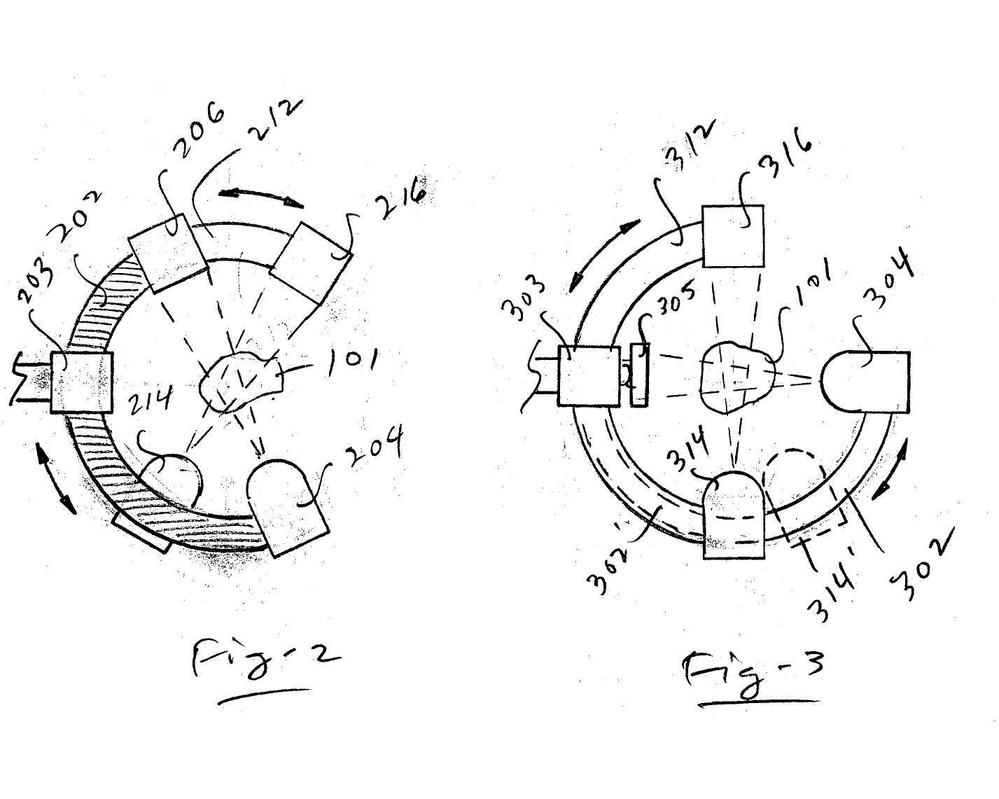

FIG. 2 is a simplified diagram of one embodiment of the invention, wherein two C-arms 202 and 212 are adjustably mounted on the same support 204, allowing the arms to be independently positioned, including use for obtaining orthogonal views. In this case, arm 202 includes an emitter 204 and detector 206, and arm 212 includes an emitter 214 and a detector 216. Both are slidably received by the holder 203, allowing them to be positioned more or less as shown to image a target 101, then rotated to obtain different views, similar to the configuration shown in FIG. 3.

Although the emitters are shown at the bottom directed toward detectors at the top, the invention is not limited in this regard. Also, the holder 203, though shown in a horizontal orientation, may be moved up or down from the horizon, enabling one of the emitter-detector pairs to image in a horizontal plane, with the other emitter-detector pair imaging in a vertical plane. In this particular embodiment, the emitters and detectors may need to be offset from their respective arms so that a true orthogonal view may be imaged of the target 101. Although the arms are shown as moving independently of one another, it will be appreciated that some form of indicator or indent, or locking mechanism would be provided when the two emitters and detectors are at 90 degrees from one another.

FIG. 3 illustrates an alternative embodiment of the invention, wherein the holder 303 includes a detector 305, receiving energy from emitter 304. Alternatively, the position of the emitter and detector may be reversed. In this and in other embodiments, the detector (or emitter) may be pivotally mounted to adjust alignment. An arm 312 having a second emitter-detector pair including emitter 314 and detector 316, is movable within the holder 304, with a second arm 302 being slidably engaged within one portion of the arm 312. This enables the arm 302 to be moved with the emitter 304 in position 314, allowing the entire assembly to be moved over and around a target 101, at which point the emitter (or detector) 304 may be rotated upwardly, thereby forming orthogonal and alternative imaging axes.

The invention is also not limited in terms of the technology used for image formation, processing, or display, as these are either well known in the art, or continually advancing. A U.S. patent that shows at least some processing components is U.S. Pat. No. 6,236,712, incorporated herein by reference. Other patents and construction/operation/maintenance manuals for existing C-arms may also teach hardware and software applicable to this invention.

As discussed hereinabove, by mounting two separate emitter-detector pairs on the same C-arm assembly, different views, including orthogonal views, may be taken through a target without having to reposition a single C-arm and depending upon the embodiment, without duplicating an entire piece of equipment by having a second C-arm. For example, the different views made possible by the invention may be taken at different times, thereby allowing much of the bulk of the processing and image formation circuitry and display apparatus to be commonly used. The views may be taken immediately after one another, however, with both views being visible on different screen displays, as shown in FIG. 5. A target view with crosshairs, for example is also preferably provided. In an alternative, more comprehensive embodiment of the invention, processing hardware and software and image formation electronics may be duplicated, allowing for orthogonal (or views at other angles) to be taken simultaneously. Three-dimensional reconstructions of the target may further be possible, by storing views taken at different times or more expeditiously through simultaneous multiple-view imaging.

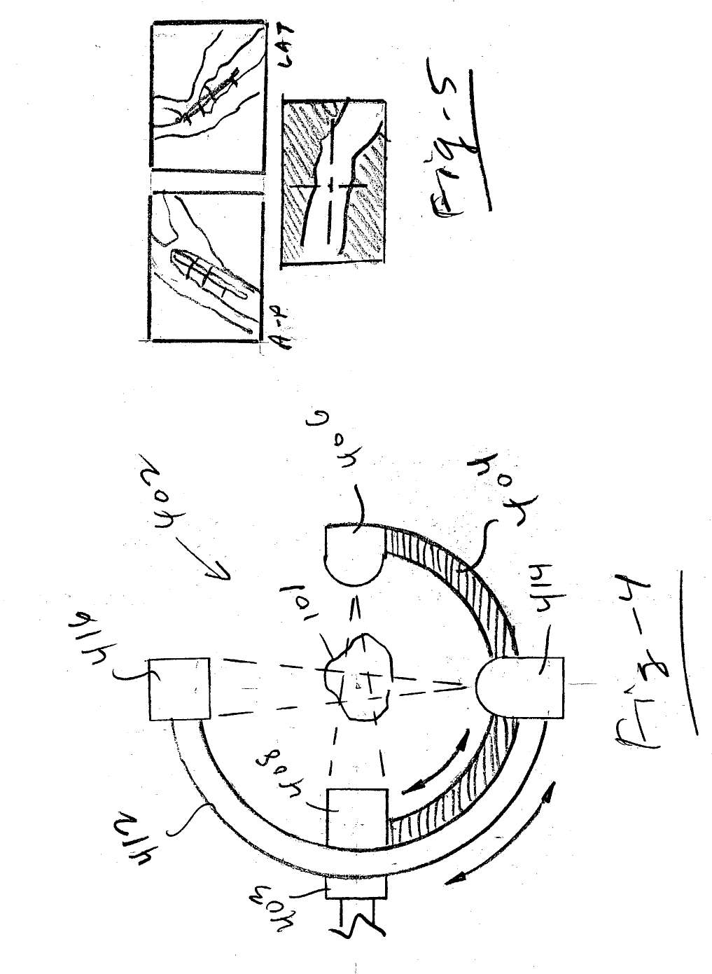

FIG. 4 illustrates a further alternative embodiment of the invention depicted generally at 402. In this configuration a first C-arm 412 having an emitter 414 and detector 416 is slidingly engaged in a mount 403, and a second C-arm 404 having a second emitter-detector pair 406, 408 is received by the first C-arm as an inner concentric ring. This allows the second arm to slide out of the way to receive the target 101, then repositioned as shown for orthogonal imaging.

I claim:

1. An improved C-arm assembly for imaging a target, comprising:
a first emitter-detector pair arranged to image the target along a first axis; and
a second emitter-detector pair, physically coupled to the first emitter-detector pair, for imaging the target along a second axis different from the first.

2. The improved C-arm assembly of claim 1, wherein the first and second axes are orthogonal to one another.

3. The improved C-arm assembly of claim 1, wherein the relationship between the first emitter and detector is fixed on a first C-arm.

4. The improved C-arm assembly of claim 3, wherein:
the relationship between the second emitter and detector is fixed on a second C-arm; and
the first and second C-arms are physically coupled to one another.

5. The improved C-arm assembly of claim 4, wherein at least a portion of the first and second C-arms are co-extensive with one another.

6. The improved C-arm assembly of claim 4, wherein at least a portion of the second C-arm slidingly engages within or beside the first C-arm.

7. The improved C-arm assembly of claim 1, wherein at least one of the first and second emitters or detectors are pivotally mounted for axial adjustment.

8. The improved C-arm assembly of claim 1, wherein the first and second emitter-detector pairs facilitate simultaneous anterior-posterior and lateral views through the target.

9. The improved C-arm assembly of claim 1, wherein the first and second emitter-detector pairs facilitate a three-dimensional reconstruction of the target.
